(19) United States
(12) Patent Application Publication
(10) Pub. No.: US 2014/0024980 A1
(43) Pub. Date: Jan. 23, 2014

(54) Medical Sexual Stimulator

(71) Applicant: Juan Jose Ortiz, Alexandria, VA (US)

(72) Inventor: Juan Jose Ortiz, Alexandria, VA (US)

(21) Appl. No.: 13/554,759

(22) Filed: Jul. 20, 2012

(51) Int. Cl. A61H 1/00

(52) U.S. Cl. 601/46

(57) ABSTRACT

A medical sexual stimulator includes a J-shaped tubular housing having a distal end and a proximal end. A mechanism is for vibrating the J-shaped tubular housing. When a hand of a person grips the proximal end and inserts the distal end of the J-shaped tubular housing within a body orifice of the person erotic sexual activities will be provided.

### BACKGROUND OF THE INVENTION

1. Field of the Invention

The present invention relates to a vibrating sex aid, and more particularly, a medical sexual stimulator.

Currently, sex toys or sexual stimulators are popular, because they can increase sexual feelings or desires for intercourse. Conventionally, such vibration type sex toys are provided with vibrators operated by batteries. However, they are not convenient for self-use. Typical artificial dildos are hand-held and require that a user either have a partner or have to contort their body in unusual positions to achieve a proper and repeated insertion. Thus, continuing improvements in the exploitation of the drive of vibration type sex toys are constantly being sought.

The use of sex aids is for increasing sexual stimulation. Therefore, it can be appreciated that there exists a previously unappreciated need for a new and improved sex aid that allows an internal vibrator with an internal vibrating circuit for the purposes of increasing erotic sex activities.

Accordingly, there is a need for a medical sexual stimulator that is compact in size and easy to manipulate. In addition, there is a need for a medical sexual stimulator that can be easily moved with minimal strain on the hands, wrists and forearms. The present invention fulfills these needs and provides other related advantages.

2. Description of the Prior Art

Numerous innovations for massaging devices have been provided in the prior art that will be described. Even though these innovations may be suitable for the specific individual purposes to which they address, however, they differ from the present invention.

A FIRST EXAMPLE, U.S. Patent Office Publication No. 2004/0186344, Published on Sep. 23, 2004, to Jannuzzi teaches a sexual aid device comprising a curved portion having a proximal and a distal end, a substantially straight portion, the straight portion extending from the proximal end of the curved portion thereby forming an approximate J shape, and mechanical means for causing movement of the curved portion. The movement can be arcuate, circular, vibratory, an extending movement or a “come hither” movement. The distal end of the curved portion stimulates a female's Grafenberg spot or G spot when the device is inserted into the vagina with the straight portion pointing away from the curved portion towards the female's torso. The straight portion extends coextensively from the curved portion. The device also includes a clitoral stimulation portion which is textured and vibrates.

A SECOND EXAMPLE, U.S. Patent Office Publication No. 2008/0139980, Published on Jun. 12, 2008, to Fladl et al. teaches a vibrostimulation device for slidingly communicating with tactile receptors in a human body. The device comprises an elongate vibrator module and a handle component configured for releasably engaging and rotationally communicating with the vibrator module. The vibrator module comprises a vibrating end portion containing therein an electrically controllable vibratory apparatus interconnected by a resilient shock-absorbing coupler to a power supply module. The resilient shock-absorbing coupler is configured to extend the vibrating portion away from the power supply module at an acute angle. The handle component comprises a base portion configured for releasably engaging and rotationally cooperating with the power supply module of the vibrator module, a vertical member pivotably cooperating with the base portion, and a cantilevered upper portion extending outward from the vertical portion. The upper handle portion is provided with a switching device that cooperates with the base handle portion for electrically controlling the vibrator module.

A THIRD EXAMPLE, U.S. Patent Office Publication No. 2009/0247915, Published on Oct. 01, 2009, to Imboden et al. teaches a vibrating massager that includes a housing, a power source supported by the housing and a replaceable motor. The housing and motor are configured so that the motor may be readily replaced by a human operator without the need to replace the housing, power source, or other components. The motor may be sized and configured to substitute for a conventional battery in a multi-battery device. When positioned in place of a battery in a supporting device, the motor operates to impart a vibrating motion to the supporting device.

A FOURTH EXAMPLE, U.S. Patent Office Publication No. 2010/0041944, Published on Feb. 18, 2010, to Levy teaches a sexual stimulation device and method that provides highly varied and dynamically controllable sensations, both directly under manual control of the user and indirect electronic control, and in such a way as to provide sensations to specific regions of the sexual organs.

A FIFTH EXAMPLE, U.S. Patent Office Publication No. 2011/0082332, Published on Apr. 07, 2011, to Lee teaches a mechanized dildo having a body with a plurality of vibrator assemblies, each vibrator assembly comprising a motor and a housing; a processor electrically coupled to each of the plurality of vibrator assemblies; a battery electrically coupled to the processor; at least one mode control switch electrically coupled to the processor; a phallic sleeve comprising an elastic material covers the plurality of vibrator assemblies; and a housing containing the processor, the battery and the at least one control switch; wherein the processor is configured to operate separate vibrator assemblies in different combination modes, such modes being selected using the at least one mode control switch.

It is apparent now that numerous innovations for massaging devices have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a medical sexual stimulator that avoids the disadvantages of the prior art.

ANOTHER OBJECT of the present invention is to provide a medical sexual stimulator that is simple and inexpensive to manufacture.

STILL ANOTHER OBJECT of the present invention is to provide a medical sexual stimulator that is simple to use.

BRIEFLY STATED, STILL YET ANOTHER OBJECT of the present invention is to provide a medical sexual stimulator which comprises a J-shaped tubular housing having a distal end and a proximal end. A mechanism is for vibrating the J-shaped tubular housing. When a hand of a person grips the proximal end and inserts the distal end of the J-shaped tubular housing within a body orifice of the person erotic sexual activities will be provided.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a diagrammatic illustrative side view partly in cross section of the present invention; and

FIG. 2 is a diagrammatic illustrative front view showing the present invention in use.

### REFERENCE NUMERALS UTILIZED IN THE DRAWING

110 medical sexual stimulator
112 J-shaped tubular housing of stimulator 110
114 distal end of housing 112
116 proximal end of housing 112
118 vibrating mechanism of stimulator 110
120 hand of person 122
122 person
124 first straight segment of housing 112
126 second curved segment of housing 112
128 connector of housing 112
130 end cap of housing 112
132 free end of first straight segment 124
134 battery of mechanism 118
136 vibrating circuit of mechanism 118
138 slide switch of mechanism 118
140 vibrator of mechanism 118
142 dildo of stimulator 110
144 silicon material of dildo 142
146 first portion of second curved segment 126
148 second portion of second curved segment 126
150 third portion of second curved segment 126

### DETAILED DESCRIPTION OF THE PREFERRED EMBODIMENT

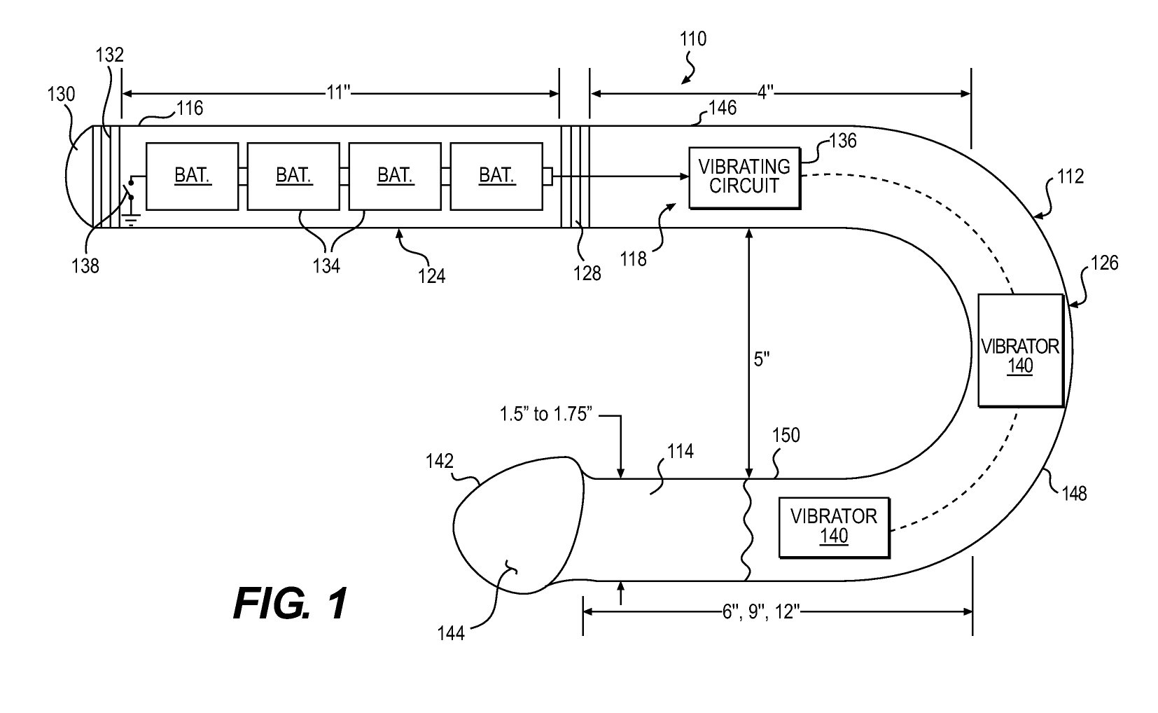

As shown in FIG. 1, the present invention is a medical sexual stimulator 110 which comprises a J-shaped tubular housing 112 having a distal end 114 and a proximal end 116. A mechanism 118 is for vibrating the J-shaped tubular housing 112.

The J-shaped tubular housing 112 is comprised of a first straight segment 124 and a second curved segment 126. A connector 128 attaches the first straight segment 124 to the second curved segment 126. An end cap 130 is threaded onto a free end 132 of the first straight segment 124.

The vibrating mechanism 118 consists of at least one battery 134 that is carried within the first straight segment 124. A vibrating circuit 136 is carried within the second curved segment 126 and is electrically connected to the least one battery 134. A slide switch 138 is mounted onto the first straight segment 124 and is electrically connected between the at least one battery 134 and the vibrating circuit 136. The slide switch 138 has a low, medium and high speed for vibration. At least one vibrator 140 is carried within the second curved segment 126 and is electrically connected to the vibrating circuit 136.

The stimulator 110 further comprises a dildo 142 located on the distal end 114 of the J-shaped tubular housing 112. The dildo 142 is comprised of a soft silicon material 144 and is shaped like a penis for penetration within the body orifice. The body orifice can be a vagina or an anus.

The first straight segment 124 of the J-shaped tubular housing 112 has a length of approximately eleven inches. The second curved segment 126 is comprised of a first portion 146 having a length of approximately four inches, a second portion 148 having a length of approximately five inches and a third portion 150 having a length of approximately six, nine or twelve inches.

The diameter of the dildo 142 is approximately one and a half inches to one and three quarter inches. The at least one battery 134 is of a size of approximately one and half volts to twelve volts.

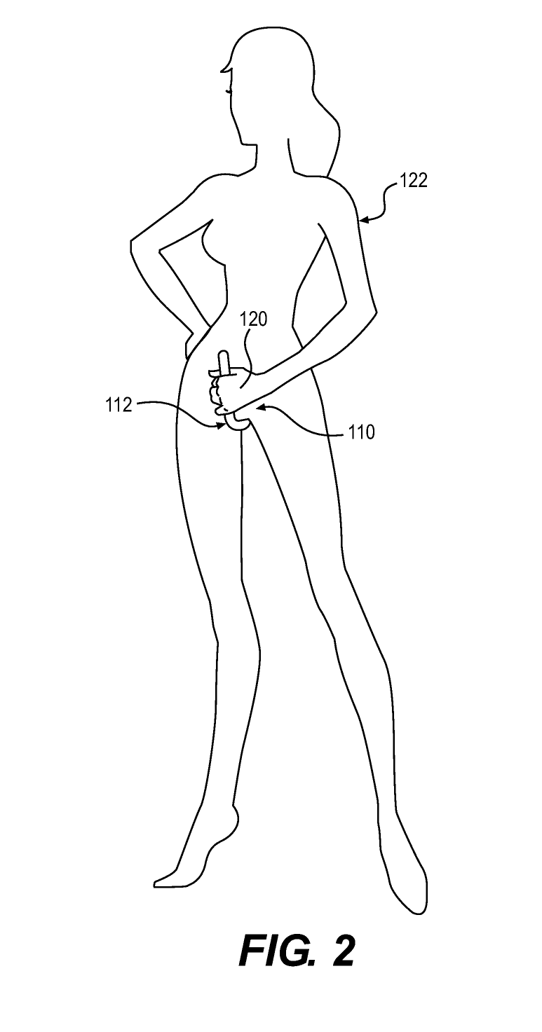

As shown in FIG. 2, when a hand 120 of a person 122 grips the proximal end 116 and inserts the distal end 114 of the J-shaped tubular housing 112 within a body orifice of the person 122 erotic sexual activities will be provided.

It will be understood that each of the elements described above, or two or more together, may also find a useful application in other types of constructions differing from the types described above.

While the invention has been illustrated and described as embodiments of a medical sexual stimulator, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A medical sexual stimulator which comprises:
a) a J-shaped tubular housing having a distal end and a proximal end; and
b) means for vibrating the J-shaped tubular housing, so that when a hand of a person grips the proximal end and inserts the distal end of the J-shaped tubular housing within a body orifice of the person erotic sexual activities will be provided.

2. The stimulator as recited in claim 1, wherein the J-shaped tubular housing comprises:
a) a first straight segment;
b) a second curved segment;
c) a connector to attach the first straight segment to the second curved segment; and
d) an end cap threaded onto a free end of the first straight segment.

3. The stimulator as recited in claim 2, wherein the vibrating means comprises:
a) at least one battery carried within the first straight segment;
b) a vibrating circuit carried within the second curved segment, electrically connected to the least one battery;
c) a slide switch mounted onto the first straight segment electrically connected between the at least one battery and the vibrating circuit, the slide switch having a low, medium and high speed for vibration; and
d) at least one vibrator carried within the second curved segment electrically connected to the vibrating circuit.

4. The stimulator as recited in claim 1, further comprising a dildo located on the distal end of the J-shaped tubular housing.

5. The stimulator as recited in claim 4, wherein in dildo is comprised of a soft silicon material.

6. The stimulator as recited in claim 5, wherein the dildo is shaped like a penis for penetration within the body orifice.

7. The stimulator as recited in claim 6, wherein the body orifice is a vagina.

8. The stimulator as recited in claim 6, wherein the body orifice is an anus.

9. The stimulator as recited in claim 2, wherein the first straight segment of the J-shaped tubular housing has a length of approximately eleven inches.

10. The stimulator as recited in claim 2, wherein the second curved segment comprises:
a) a first portion having a length of approximately four inches;
b) a second portion having a length of approximately five inches; and
c) a third portion having a length of approximately six, nine or twelve inches.

11. The stimulator as recited in claim 5, wherein the diameter of the dildo is approximately one and a half inches to one and three quarter inches.

12. The stimulator as recited in claim 3, wherein the at least one battery is of a size of approximately one and half volts to twelve volts.
